(19) United States
(12) Patent Application Publication
(10) Pub. No.: US 2005/0159191 A1
(43) Pub. Date: Jul. 21, 2005

(54) Dockable cellular phone

(75) Inventor: William Gabriel Pagan, Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/761,661

(22) Filed: Jan. 21, 2004

(51) Int. Cl. H04B 1/00

(52) U.S. Cl. 455/575.1

(57) ABSTRACT

A system that permits a cell phone user to insert a cell phone, which has a PCMCIA compliant connector, directly into a computer's PC card socket. The cell phone is hinged about a first component and a second component. The first component includes a keypad appropriate for dialing up an Internet service provider (ISP), and the second component is PCMCIA compliant to couple directly in an existing PC socket of the computer. Thus, the cell phone requires no additional cables or modified ports to provide a seamless connection to a dial-up ISP.

### BACKGROUND OF THE INVENTION

1. Technical Field

This invention relates generally to wireless communication, and in particular to wireless phones used to connect a computer with a computer network. Still more particularly, the present invention relates to a cell phone that can be directly plugged into a computer to provide wireless communication between the computer and the computer network using an existing port or socket in the computer.

2. Description of the Related Art

While most early generation and many present generation computers are hardwired when connected to a network, a popular alternative is wireless connections. Such wireless connections are usually to a local area network (LAN) via a radio connection in compliance with the IEEE 802.11 standard. A typical LAN/computer connection is illustrated as a LAN 100 in FIG. 1.

A computer 102 is connected to a wireless transceiver 104. Wireless transceiver 104 communicates via radio waves to a wireless router 106, which connects to a network 110 (typically the Internet) via a modem 108, which may be a true modulator/demodulator if the connection to network 110 is an analog dial-up connection, or simply a router or hub if the connection to network 110 is via a digital line, such as a cable, an ISDN (Integrated Services Digital Network) adapter, etc.

With reference to FIG. 2a, wireless transceiver 104 is often connected to computer 102 via a Personal Computer Memory Card International Association (PCMCIA) PC card socket 202, shown in FIG. 2b. Communication between computer 102 and wireless router 106 is accomplished by entering commands using a keyboard 204. For purposes of clarity later, note that keyboard 204 is part of a base 210, which couples to a display 206 using display hinges 208.

A limitation to LAN 100 is that wireless transceiver 104 must be within range of wireless router 106, typically less than 150′. If a user wishes to be able to connect to network 110 and be able to move about farther away, then another wireless system must be employed. For example, a cell phone system, such as shown in FIG. 3, may be used. Computer 102 can connect to a modem 302, which if external must be connected to computer 102 via a cable 310 connecting port 306a to port 306b, as shown. Modem 302 must connect to an external cell phone 304, which connects via another cable 312, which is inserted into ports 308a and 308b.

In the system depicted in FIG. 3, a user calls a dial-up Internet Service Provider (ISP) 306, which provides a gateway to network 110. Such systems are cumbersome, however, as they require connection cable 312 between modem 302 and cell phone 304, as well as appropriate and often proprietary (customized) ports 308

Thus, there is a need for a method and system that allows a user to utilize a cell phone to provide a wireless communication to an ISP without the need for external cables or customized ports.

### SUMMARY OF THE INVENTION

As will be seen, the foregoing invention satisfies the foregoing needs and accomplishes additional objectives. Briefly described, the present invention provides a system that permits a cell phone user to insert a cell phone, which has a PCMCIA compliant connector, directly into a computer's PC card socket.

The cell phone is hinged about a first component and a second component. The first component includes a keypad appropriate for dialing up an Internet service provider (ISP), and the second component is PCMCIA compliant to couple directly in an existing PC socket of the computer. Thus, the cell phone requires no additional cables or modified ports to provide a seamless connection to a dial-up ISP.

### BRIEF DESCRIPTION OF THE DRAWINGS

The novel features believed characteristic of the invention are set forth in the appended claims. The invention itself, however, as well as the preferred modes of use, further objects and advantages thereof, will best be understood by reference to the following detailed description of an illustrative embodiment when read in conjunction with the accompanying drawings, wherein:

FIG. 1a depicts a prior art Local Area Network (LAN) using an IEEE 802.11 connection;

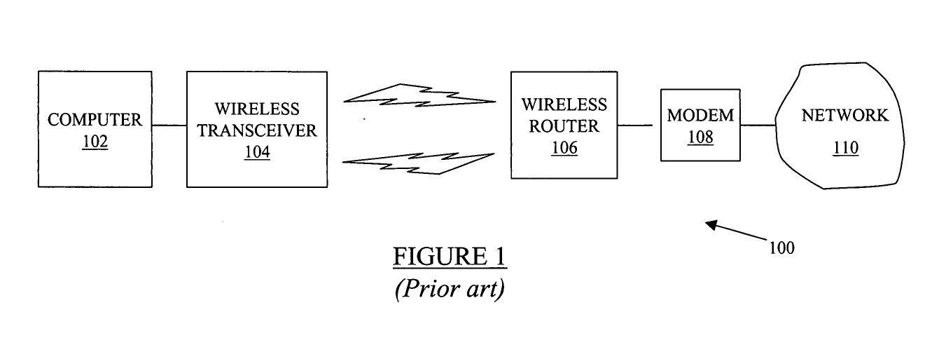

FIGS. 2a-b illustrate the use of a PC card socket for connecting an IEEE 802.11 Wi-Fi transceiver;

FIG. 3 depicts a system using a dial-up Internet Service Provider (ISP);

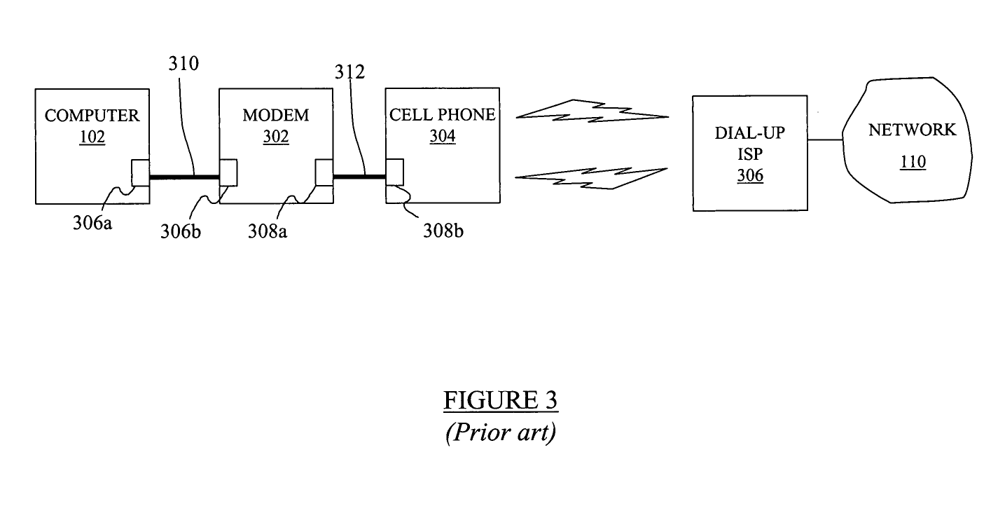

FIGS. 4a-c depict a cell phone having an integrated PC Card interface;

FIG. 4d illustrates the cell phone inserted in a PC Card socket in a computer;

FIGS. 5a-c depict the cell phone having a USB compliant plug;

FIG. 5d illustrates the cell phone inserted in a USB port in the computer;

FIG. 6 depicts an exemplary cell phone system used by the present invention; and

FIG. 7 illustrates an exemplary embodiment of the computer using the inventive cell phone.

### DETAILED DESCRIPTION OF THE PREFERRED EMBODIMENT

Referring now to the drawing figures, in which like numerals indicate like elements or steps throughout the several views, the preferred embodiment of the present invention will be described. In general, the present invention provides an improved method and apparatus for connecting a cell phone to a computer.

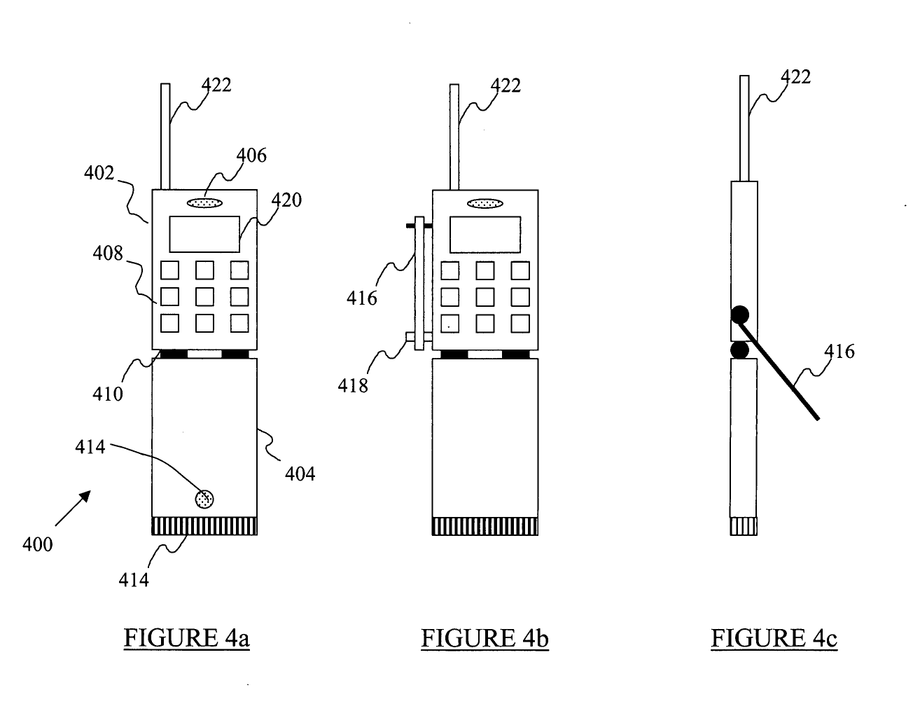

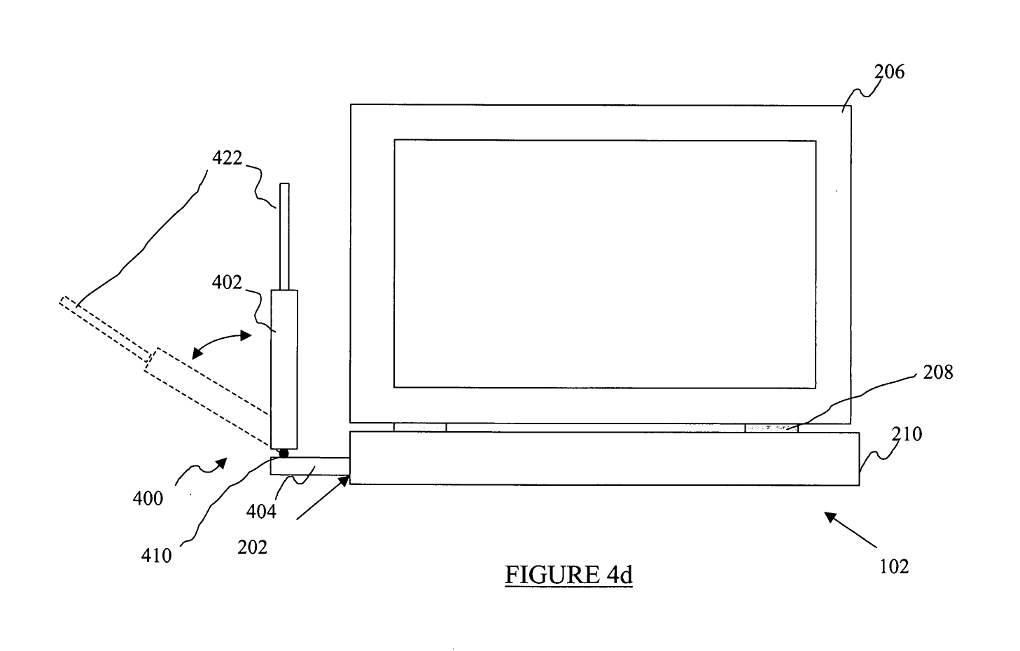

With reference now to FIG. 4a, there is depicted a cell phone 400 in a preferred embodiment of the present invention. Cell phone 400 includes a first component 402 permanently connected to a second component 404 by hinges 410. First component 402 includes an internal speaker 406, a display 420 for displaying telephone numbers, messages, etc., a keypad 408 for dialing telephone numbers, searching databases, etc., and an antenna 422. Second component 404 includes an internal microphone 412 and an electrical connector 414.

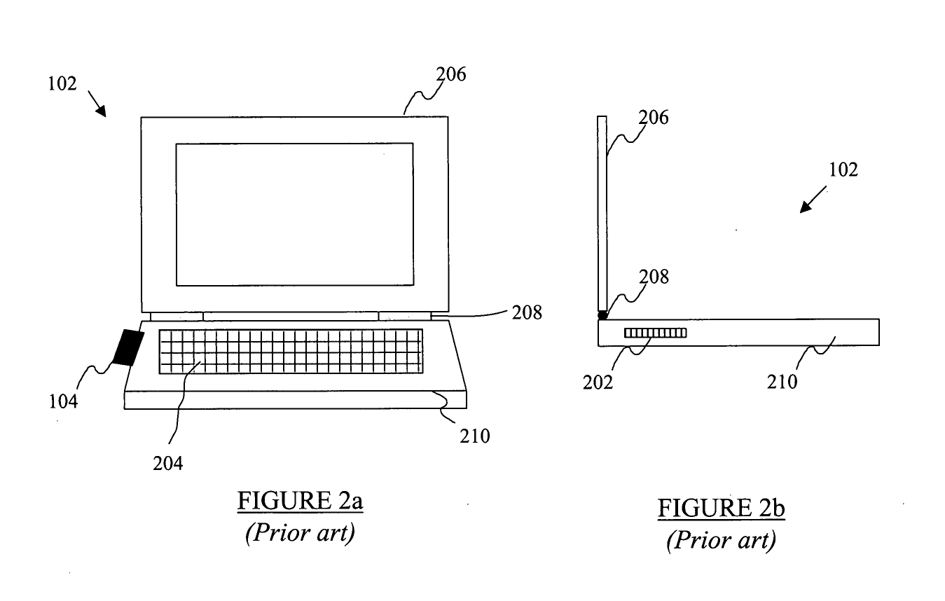

In a preferred embodiment, second component 404 has dimensions that allow physical insertion into an existing interface port of a computer, such as PC card socket 202 shown in FIG. 2b. To be capable of such a physical insertion, second component 404 preferably has a width of 54.0 millimeters (mm) and a length of 85.6 mm. In a preferred embodiment, the thickness of second component 404 is 5.0 mm, in order to mimic a Type II PC Card. Alternatively, the thickness of second component 404 is 3.3 mm, in order to mimic a Type I PC Card, or the thickness of second component 404 is 10.5 mm., in order to mimic a Type III PC Card. Note that all references herein to PC Cards and PCMCIA are understood to refer to devices that are compliant with PCMCIA Standard Release 2.1/JEIDA 4.2—July 1993 and/or earlier/later releases, and/or PC Card Standard 8.0 Release—April 2001 and/or earlier/later releases, published by the Personal Computer Memory Card International Association (PCMCIA), which are herein incorporated in their entirety by reference.

In an alternative embodiment, cell phone 400 has an external microphone 416, shown in FIG. 4b, that hinges about a swivel 418. External microphone 416 can swing down, as shown in FIG. 4c, when cell phone 400 is being used as a standalone voice telephone.

Referring now to FIG. 4d, when second component 404 is inserted into PC card socket 202, first component 402 is able to swivel around hinges 410. Thus, if the reception quality of cell phone 400 varies according to the position of antenna 422, hinge 410 permits first component 402 to swing as shown, permitting the repositioning of antenna 422 to achieve optimal reception.

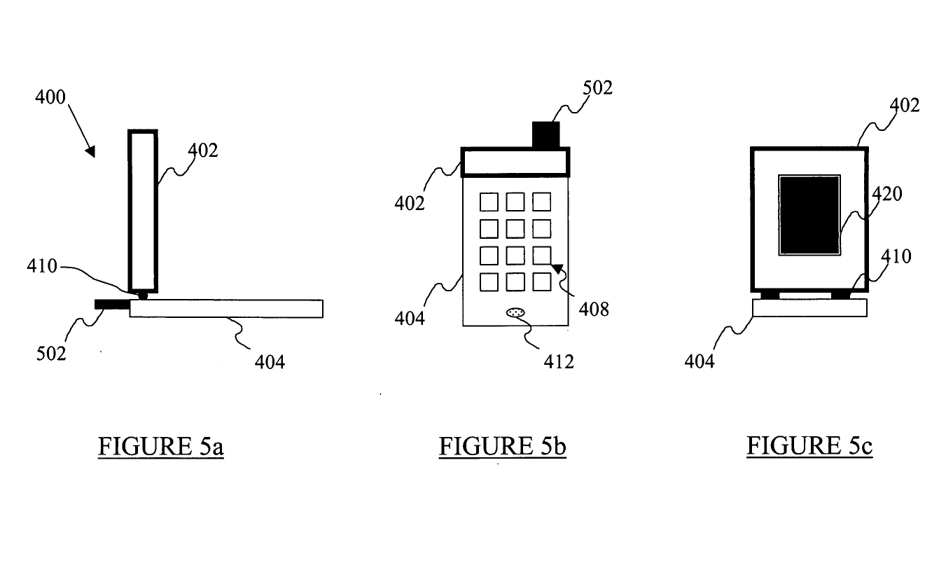

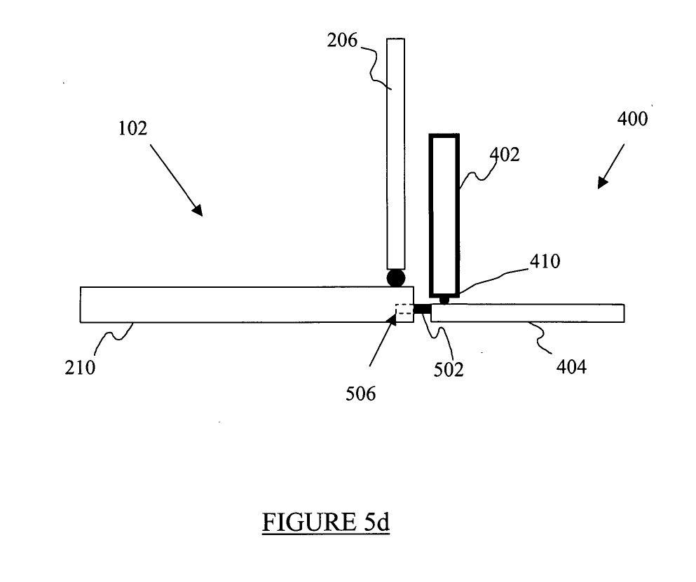

With reference now to FIGS. 5a-c, an alternative embodiment of cell phone 400 utilizing a serial plug 502 is illustrated. Serial plug 502 may be a Universal Serial Bus (USB) compliant connector, an IEEE 1394 (often referenced as “FireWire”TM) compliant connector, or other similar high-speed serial connector. FIG. 5b depicts a top view of cell phone 400, and FIG. 5c illustrates a front view of cell phone 400.

As known to those skilled in the art of computer peripheral device interfaces, the USB specification was prepared by representatives of Compaq Computer Corporation, Hewlett-Packard Company, Intel Corporation, Lucent Technologies Inc., Microsoft Corporation, NEC Corporation, and Royal Philips Electronics (Philips). Peripheral device interfaces that comply with the specification are referred to as USB interfaces and have been included in many recently developed personal computer systems. Such USB devices are generally referenced as either low-speed devices, capable of transferring data at a rate of 1.5 Megabits per second (Mb/s); or high-speed devices (also called full-speed devices) capable of transferring data at 12 Mb/s. Under the USB 2.0 specification, full-speed devices are capable of using 40× multipliers for a transfer rate of 480 Mb/s, and such USB devices are typically known as true high-speed devices.

As shown in FIG. 5d, serial plug 502 is directly physically inserted into a serial port 506, which corresponds with the type of serial plug 502. That is, if serial plug is IEEE 1394 compliant, then serial port 506 is likewise IEEE 1394 compliant in physical size and dimensions, as well as electrical and communication protocols. Similarly, if serial plug is USB compliant, then serial port 506 is likewise USB compliant.

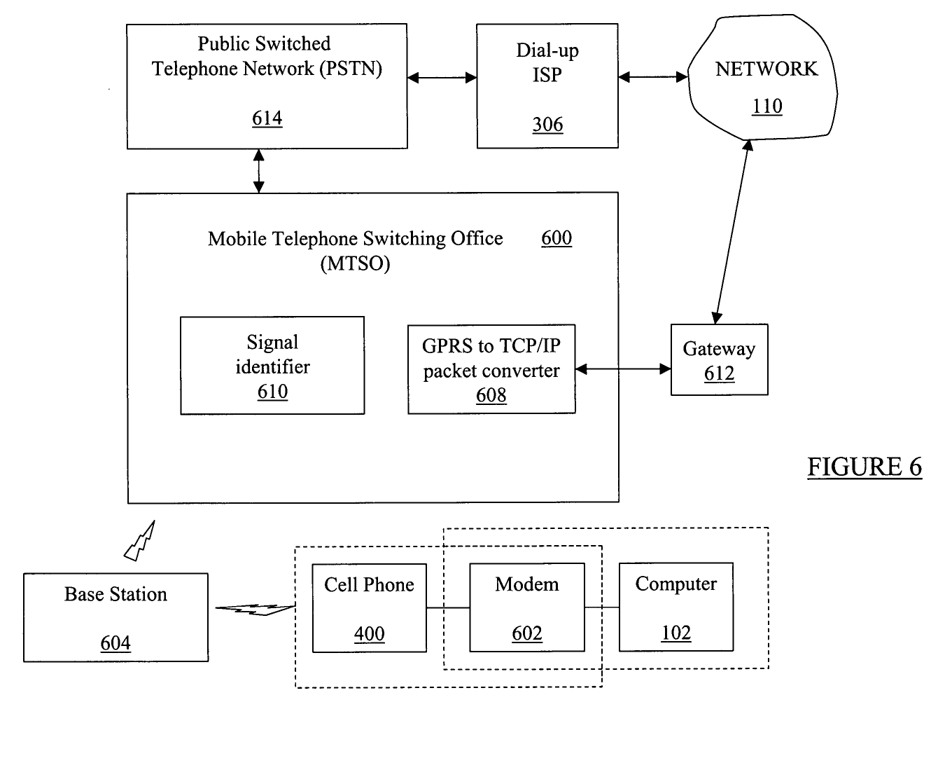

Referring now to FIG. 6, there is depicted an exemplary block diagram of a wireless telecommunications system for implementing the present invention. Cell phone 400 communicates with a base station 604, which transceives signals to a Mobile Telephone Switching Office (MTSO) 600. MTSO 600, also known as a Mobile Switching Center (MSC), aggregates and switches calls from cell phones in network of mobile phones. In a preferred embodiment of the present invention, MTSO 600 also has a signal identifier 610 that identifies what type of signal is being received from cell phone 400. That is, the signal may be either a modulated signal, or it may be a packet. 10029] If the signal is a modulated signal, then data from computer 102 is modulated onto a carrier signal, which may be either digital or analog. This modulated signal is circuit switched, like a voice signal, to a Public Switched Telephone Network (PSTN) 614. PSTN 614 then routes the modulated signal to a dial-up Internet Service Provider (ISP) 306, which connects to network 110, which is preferably the Internet. In this preferred embodiment, a modem 602 is required to modulate the carrier signal with data from computer 102. As the dotted lines indicated, modem 602 may be integrated into cell phone 400, may be integrated within computer 102, or it may be a standalone device. In the preferred embodiment, modem 602 is integrated into either cell phone 400 or computer 102, in order to take advantage of the direct connection afforded between cell phone 400 an a port in computer 102.

If the signal from cell phone 400 is identified by signal identifier 610 as a data packet, then MTSO 600 utilizes a packet converter 608. If cell phone 400 is communicating using digital data packets, these data packets must be compliant with industry standards. For example, these data packets must be compliant with a protocol such as General Packet Radio Services (GPRS), Global System for Mobile wireless service (GSM), Enhanced Data GSM Environment (EDGE), X.25 protocol of Consultative Committee for International Telegraph and Telephone (CCITT), Universal Mobile Telecommunications Service (UMTS), etc. All cited protocol standards are cited by reference in their entirety.

Communication with the Internet requires data to be in a Transmission Control Protocol/Internet Protocol (TCP/IP). Therefore, data packets from cell phone 400 must be converted from the cell phone data packet protocol (such as GPRS) to TCP/IP using packet converter 608. Once converted into the TCP/IP format, the data packet is then sent to a gateway 612, preferably part of an ISP (not shown), which accesses Internet network 110. While the data packet conversion has been shown for exemplary purposes only as going from GPRS to TCP/IP format, it is understood to be within the scope and spirit of the present invention that this data packet conversion may be from any format broadcasted from cell phone 400 to any format used by network 110.

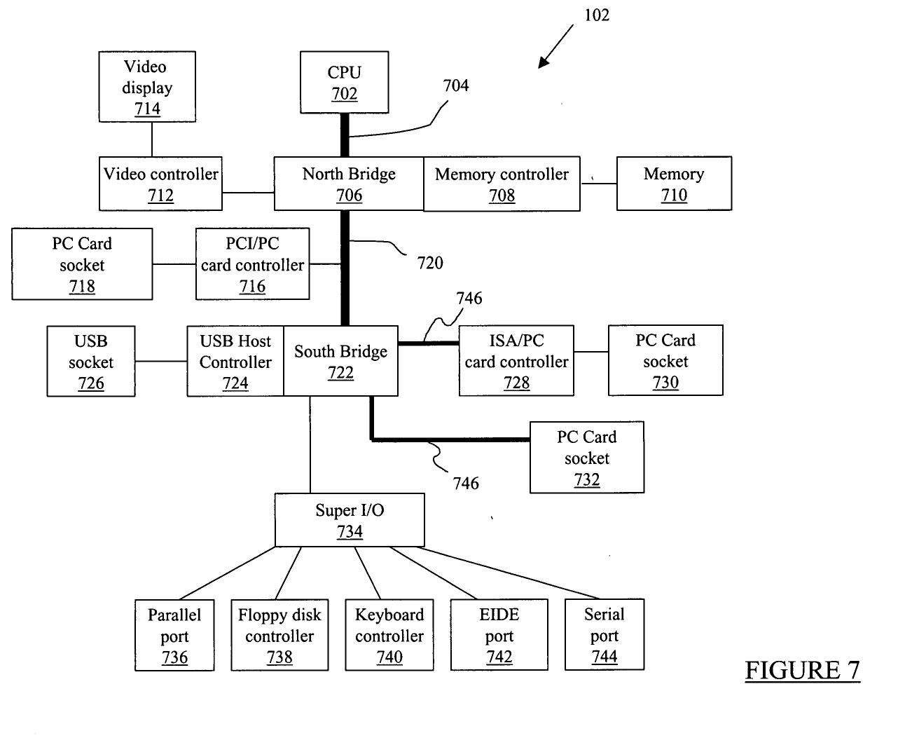

Referring now to FIG. 7, there is depicted a block diagram of a preferred embodiment of computer 102. Within computer 102, a Central Processing Unit (CPU) 702 connects via a processor interface bus 704 (also referred to in the art as a “front side bus,” “host bus,” or “system bus”) to a North Bridge 706. North Bridge 706 is a chip or chipset arbiter logic circuit having a memory controller 708 connected to a system memory 710. A video controller 712 is coupled to North Bridge 706 and a video display 714. Also connected to North Bridge 706 is a high speed interconnect bus 720. North Bridge 706 is connected via interconnect bus 720, which may be a Peripheral Component Interconnect (PCI) bus, to a South Bridge 722.

South Bridge 722 is a chip or chipset Input/Output (I/O) arbiter that includes the necessary interface logic to convey signals from interconnect bus 720 to (typically slower) I/O interfaces, including a Super I/O 734. Super I/O 734 is a chip or chipset including necessary logic and interfaces for a parallel port 736 and a non-USB (Universal Serial Bus) serial port 744, as are understood in the art of computer architecture. Super I/O 734 may also include controllers for non-USB devices such as a keyboard controller 740 for a non-USB keyboard and an Enhanced Integrated Device Electronics (EIDE) port 742, to which is connected a Compact Disk—Read Only Memory (CD-ROM) drive (not shown). Also connected to Super I/O 734 is a floppy disk controller 738, which supports an interface with one or more floppy disk drives (not shown).

If interconnect bus 720 is a PCI bus, that a PCI/PC card controller 716 can be used to interface with a PC Card socket 718, which includes one or more 68-pin PC Card sockets. Similarly, coming off South Bridge 722 may be an International Standard Architecture (ISA) bus 746, which communicates with an ISA/PC Card controller 728, which provides an interface between ISA bus 746 and PC Card socket 730, which may be the same as PC Card socket 718 is appropriate control circuitry (not shown) is provided. In addition, South Bridge 722 can support a Card Bus 746, which provides a 32-bit connection directly to a PC Card socket 732, which may also be the same as PC Card sockets 730 or 718.

Coupled with South Bridge 722 is a USB host controller 724, which provides a USB socket 726 from USB compliant devices (not shown) to computer 102 and CPU 704. USB compliant devices may be floppy disk drives, CD-ROM drives, keyboards and other peripheral devices that are configured to comply with the “Universal Serial Bus Specification” release 2.0, Apr. 27, 2000 (USB.org), which release or later is herein incorporated by reference in its entirety. For example, USB socket 726 may be directly connected to USB serial plug 502 shown in FIG. 5a. USB host controller 724, which is likewise USB compliant, may be implemented in a combination of hardware, firmware and/or software.

Although not shown in FIG. 7, a modem may be incorporated to modulate data onto a carrier signal being sent to any PC Card socket. This modem may be oriented in any technically feasible location within computer 102.

The present invention has been described in relation to particular embodiments that are intended in all respects to be illustrative rather than restrictive. Alternative embodiments will become apparent to those skilled in the art to which the present invention pertains without departing from its spirit and scope. Accordingly, the scope of the present invention is defined by the appended claims rather than the foregoing discussion.

1. A wireless phone comprising:
a first component;
a second component permanently hinged to the first component;
a keypad in the first component, the keypad allowing entry of a telephone number to be called to connect to a computer network; and
a connector in the second component, the connector in the second component being adapted to be directly physically inserted into an existing interface port in a computer.

2. The wireless phone of claim 1, wherein the second component is configured as a PC Card.

3. The wireless phone of claim 2, wherein the PC Card is a Type I card.

4. The wireless phone of claim 2, wherein the PC Card is a Type II card.

5. The wireless phone of claim 2, wherein the PC Card is a Type III card.

6. The wireless phone of claim 1, wherein the connector is a USB plug.

7. The wireless phone of claim 2, wherein a signal from the existing interface port of the computer and the connector in the second component of the wireless phone is a modulated signal.

8. The wireless phone of claim 2, wherein a signal from the existing interface port of the computer and the connector in the second component of the wireless phone is a data packet.

9. A system comprising:
a wireless phone comprising:
a first component,
a second component permanently hinged to the first component,
a keypad in the first component, the keypad allowing entry of a telephone number to be called to connect to a computer network, and
a connector in the second component; and
a computer comprising:
an interface port capable of connecting with the connector in the second component of the wireless phone,
wherein the connector in the second component is directly physically inserted into the interface port in a computer to provide a wireless connection to a network.

10. The system of claim 9, wherein the second component is configured as a PC Card.

11. The system of claim 10, wherein the PC Card is a Type I card.

12. The system of claim 10, wherein the PC Card is a Type II card.

13. The system of claim 10, wherein the PC Card is a Type III card.

14. The system of claim 9, wherein the connector is a USB plug.

15. The system of claim 10, wherein a signal from the existing interface port of the computer and the connector in the second component of the wireless phone is a modulated signal.

16. The system of claim 10, wherein a signal from the existing interface port of the computer and the connector in the second component of the wireless phone is a data packet.
